(19) United States
(12) Patent Application Publication
(10) Pub. No.: US 2008/0103966 A1
(43) Pub. Date: May 1, 2008

(54) SYSTEM AND/OR METHOD FOR DYNAMIC DETERMINATION OF TRANSACTION PROCESSING FEES

(76) Inventor: Chuck Foster, Yountville, CA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/554,894

(22) Filed: Oct. 31, 2006

(51) Int. Cl. G06Q 40/00

(52) U.S. Cl. 705/39

(57) ABSTRACT

Disclosed are a system and method of determining a fee for processing a non-cash transaction between a merchant and customer.

### BACKGROUND

1. Field

The subject matter disclosed herein related to transactions between a seller and a customer.

2. Information

Technological advances in financial services have enabled efficient non-cash transactions between merchants and customers. The evolution of credit cards and debit cards have enabled efficient payment for goods and/or services without the use of cash. In such non-cash transactions, a merchant typically receives information regarding a credit and/or debit card, which is then used to process payment with a financial institution that issues the credit and/or debit card. Additionally, the use of the Internet to process transactions between merchants and customers increasingly involves transmitting a customer's sensitive financial information over public networks. Accordingly, there is a desire to provide customers with additional protection from the risks of transmitting sensitive financial information over a public network such as the Internet.

### BRIEF DESCRIPTION OF THE FIGURES

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1A is a schematic diagram of a financial transaction system according to an embodiment;

FIG. 1B is a flow diagram illustrating a process for handling fees for processing non-cash transactions according to an embodiment;

FIG. 1C is a schematic diagram of a financial transaction system according to an alternative embodiment;

FIG. 1D is a flow diagram illustrating a process for handling fees for processing non-cash transactions according to an embodiment;

FIG. 1E is a schematic diagram of a financial transaction system according to an embodiment;

FIG. 2 is a flow diagram illustrating a process for handling fees for processing non-cash transactions according to an embodiment;

FIG. 3 is a schematic diagram of a financial transaction system for paying merchant invoices according to an embodiment;

FIG. 4 is a flow diagram illustrating a process for handling fees for processing merchant invoices according to an embodiment;

FIG. 5 is a schematic diagram of a financial transaction system for making off-line purchases according to an embodiment;

FIG. 6 is a flow diagram of a process for handling processing fees in connection with off-line purchases according to an embodiment;

FIG. 7 is a schematic diagram of a computing platform according to an embodiment;

FIG. 8 is a schematic diagram of components within a computing platform according to an embodiment;

FIGS. 9A through 9D are diagrams illustrating information that may be transmitted between parties in a non-cash transaction according to an embodiment;

FIG. 10 is a purchase log of transactions according to an embodiment; and

FIG. 11 is a schematic diagram of an electronic shopping cart viewable in a graphical user interface (GUI) to enable a customer to specify purchase of goods and/or services from a merchant according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “terminating,” “downloading,” “identifying,” “initiating,” “querying,” “obtaining,” “hosting,” “maintaining,” “representing,” “modifying,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “seller” as referred to herein relates to a party and/or entity that engages in transactions to provide goods and/or services in exchange for payment. In one embodiment, a seller may comprise a “merchant” that regularly engages in providing particular goods and/or services in exchange for payment as an on-going enterprise. Alternatively, a seller may comprise a private party which is willing to provide a good and/or service on a limited basis (e.g., a private party). However, these are merely examples of a seller and claimed subject matter is not limited in this respect.

A “customer” as referred to herein relates to a party and/or entity that engages in transactions with a seller to receive such goods and/or services in exchange for payment. For example, a seller may provide goods and/or services to one or more customers in exchange for payment from such customers in the form of cash payment, credit, account debit, barter exchange and/or the like. However, this is merely an example of how a seller and customer may engage in transactions for providing goods and/or services in exchange for payment, and claimed subject matter is not limited in these respects.

According to an embodiment, a seller may provide goods and/or services to a customer for non-cash payment. In particular examples, although claimed subject matter is not limited in these respects, such non-cash payment may be financed through credit that the customer has established with a merchant or a financial intermediary using, for example, a credit card. “Credit” refers to an amount of payment a merchant and/or financial intermediary is willing to receive from a customer as a non-cash payment. Such credit may quantify an allowable account balance which the customer promises to pay at a future date. Alternatively, such credit may comprise a cash balance that the customer has established a merchant and/or a financial intermediary using, for example, a debit card. However, these are merely examples of how a seller and customer may engage in a non-cash transaction for providing goods and/or services, and claimed subject matter is not limited in these respects.

According to an embodiment, although claimed subject matter is not limited in these respects, “completion” or “termination” of a financial transaction may occur upon any one of several events associated with such completion or termination of a financial transaction. In one embodiment, completion may occur upon tendering a good and/or service to a customer, payment of funds to a merchant or a confirmation (or promise) to a merchant that payment for a good and/or service is forthcoming. However, these are merely examples of events that may be used to define a completion of a transaction and claimed subject matter is not limited in these respects. In one embodiment, termination of a transaction may occur upon an event and/or condition that prevents completion of a transaction. For example, such a termination of a transaction may occur upon an event and/or condition that prevents payment to a merchant, notice of payment and/or delivery of goods and/or services. However, this is merely an example of a termination of a transaction and claimed subject matter is not limited in this respect.

According to particular embodiments described herein, financial transactions may be completed by transmitting information over data networks using any one of several communication protocols such as, for example, the Internet protocol and related communication protocols. For convenience, references to the Internet are used herein, but embodiments are equally applicable to any type of data network, and claimed subject matter is not limited in this respect. According to particular embodiments, although claimed subject matter is not limited in this respect, a transaction between a customer and merchant may be completed without transmission of a customer's sensitive information, such as credit card information and/or other personal financial information, over the Internet. Accordingly, such sensitive information need not leave the possession of the customer to complete the transaction. Also, embodiments described herein may be suitable for use in any country and with any currency, since embodiments of the system allow financial institutions to effectuate currency exchange based on any existing exchange rates.

According to an embodiment, and as illustrated below with specific examples, a customer merchant and/or financial intermediary may be associated with a communication devices and/or computing platforms capable of communicating with one another over a data communication network. In a particular example, although claimed subject matter is not limited in this respect, a customer may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect. Also, as referred to herein, the term “message” may relate to the transmission of information from a source to a destination using any one of several mediums such as, for example, a communication network such as the Internet and other IP infrastructure (e.g., email, HTTP, XML, etc.), dialup connection, facsimile transmission, person-to-person phone conversation, just to name a few.

According to an embodiment, participants in a financial transaction system may comprise a seller, customer, and/or one or more financial intermediaries. While the following discussion illustrates interactions among such a seller, customer and a financial intermediary as a merchant, customer and financial intermediary, respectively, these are merely examples provided for illustration of a particular embodiment of a financial transaction system. Other financial transaction systems may facilitate interactions involving a customer that is not a customer, or a financial intermediary that is not a card company and/or a seller that is not a merchant, and claimed subject matter is not limited in this respect.

In transactions illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. In one example, such a merchant may operate an automatic teller machine (ATM). Here, the good and/or service being purchased by a customer is cash. However, this is merely an example embodiment and claimed subject matter is not limited in this respect.

In transaction illustrated below, a merchant may comprise any party capable of providing a good and/or service to a customer as part of a credit and/or non-cash transaction. In one particular embodiment, although claimed subject matter is not limited in this respect, a merchant may provide and/or dispense cash to a customer in a transaction that is financed by a financial intermediary. For example, such a merchant may operate an automatic teller machine (ATM). Here, the good and/or service being purchased by a customer is cash. However, this is merely an example embodiment and claimed subject matter is not limited in this respect.

According to an embodiment, a financial intermediary, such as a card company, may provide credit to a customer. For example, the financial intermediary may comprise a credit card company, a bank, a credit union, or other financial institution capable of facilitating non-cash transactions such as credit card transactions. Such credit provided to a customer can be derived from any type of account, such as a credit card account, debit card account, a bank account, savings account, checking account or brokerage account. However, these are merely examples of how credit may be provided to a customer using particular types of accounts and claimed subject matter is not limited in these respects. Therefore, virtually any type of financial institution and/or financial intermediary can provide credit to the customer based on any type of account without deviating from claimed subject matter.

In another example, individuals comprising members of a family may be authorized as customers to make purchase on behalf of the family based upon their status in the family. Here, for example, a parent may be given unlimited authority while children may have limited purchasing authority to purchase only certain goods or make purchase only from specific merchants. However, these are merely examples of how a family purchasing policy may limit purchasing authority of children and claimed subject matter is not limited in this respect.

A customer may establish an account with a financial intermediary to obtain credit which may be use to make financial transactions including, for example, purchase of goods and/or services, or payment of invoices. Such an account established by a customer may be associated with confidential personal information such as, for example, an account number and credit limit.

According to a particular embodiment, to facilitate a non-cash transaction, a financial intermediary may receive payment from a customer and pay a merchant to settle the non-cash transaction between the customer and the merchant. Here, a financial intermediary may process such a non-cash transaction by, for example, invoicing a customer, managing credit accounts, authorizing parties to participate in such a non-cash transaction and/or interacting with other financial institutions, to name just a few actions that may be taken to process a non-cash transaction. Additionally, in facilitating a non-cash transaction a financial intermediary may assume some risk that a customer defaults on payment to settle the non-cash transaction. Accordingly, a financial intermediary may assess a fee to process a non-cash transaction to one or more parties to the non-cash transaction.

According to an embodiment, although claimed subject matter is not limited in this respect, a financial intermediary may dynamically determine a fee to be assessed in connection with processing a non-cash transaction between a customer and a merchant. In a particular embodiment, such a determination of a transaction processing fee may be based, at least in part, on information available to the financial intermediary upon receiving a request for payment.

According to an embodiment, and as illustrated below with specific examples, a customer merchant and/or financial intermediary may be associated with a communication devices and/or computing platforms capable of communicating with one another over a data communication network. In a particular example, although claimed subject matter is not limited in this respect, customers may participate in non-cash transactions with a merchant by using a personal computer, cell phone, personal digital assistant, two-way pager and/or interactive television that receives user inputs from a remote control. However, these are merely examples devices that may enable a customer to participate in a non-cash transaction according to a particular embodiment and claimed subject matter is not limited in this respect.

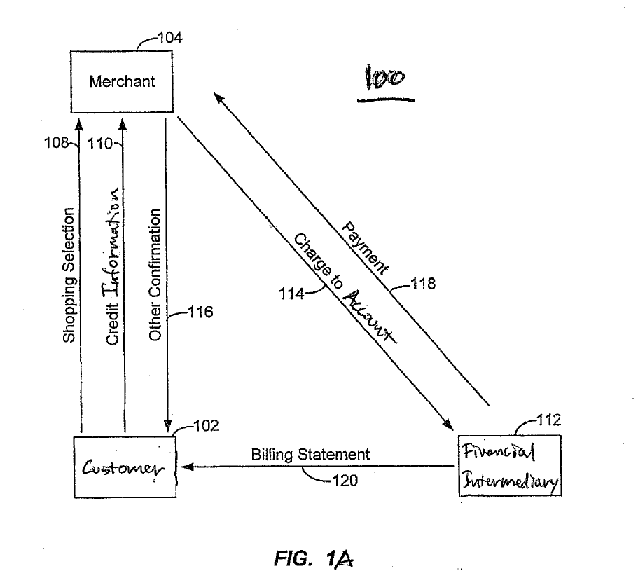

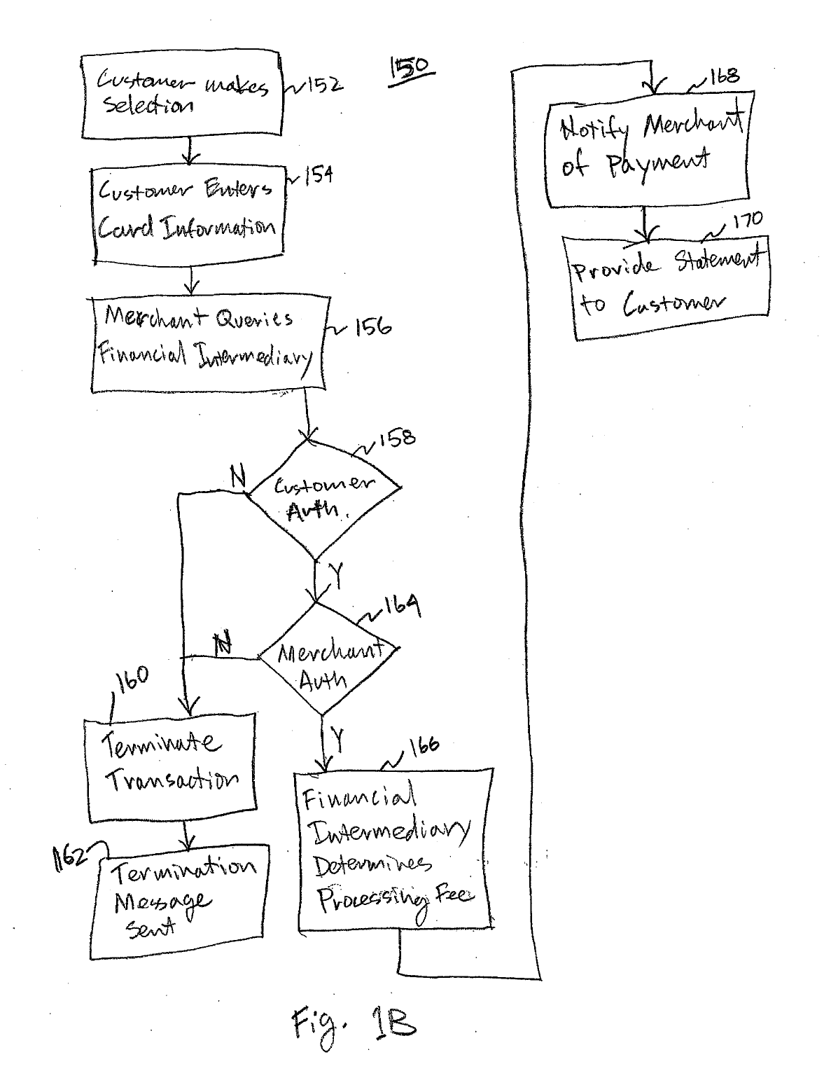

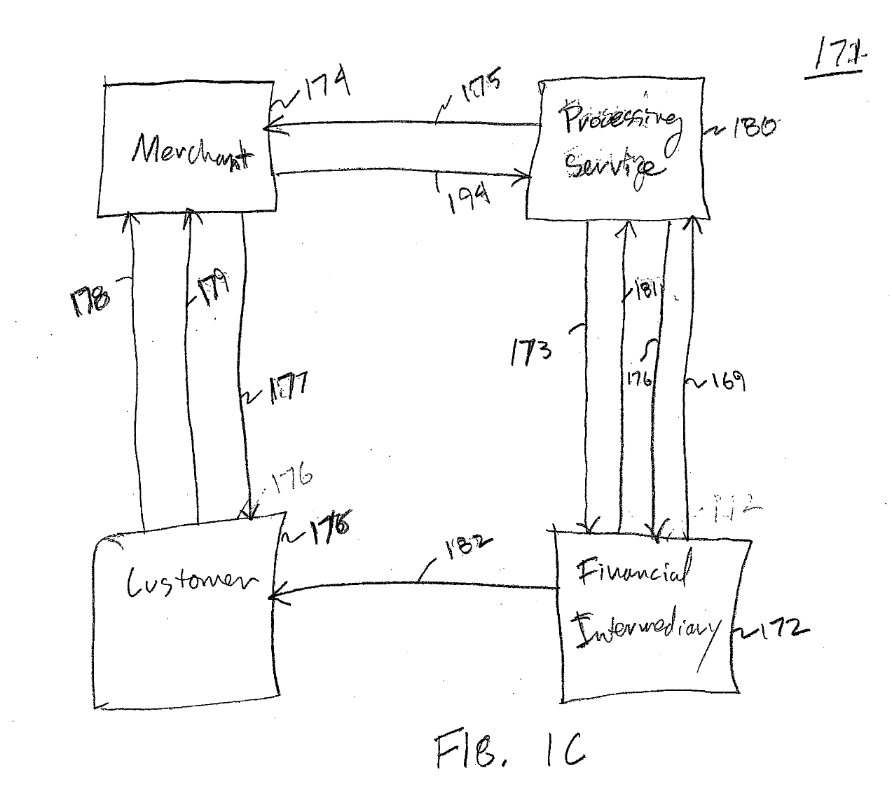

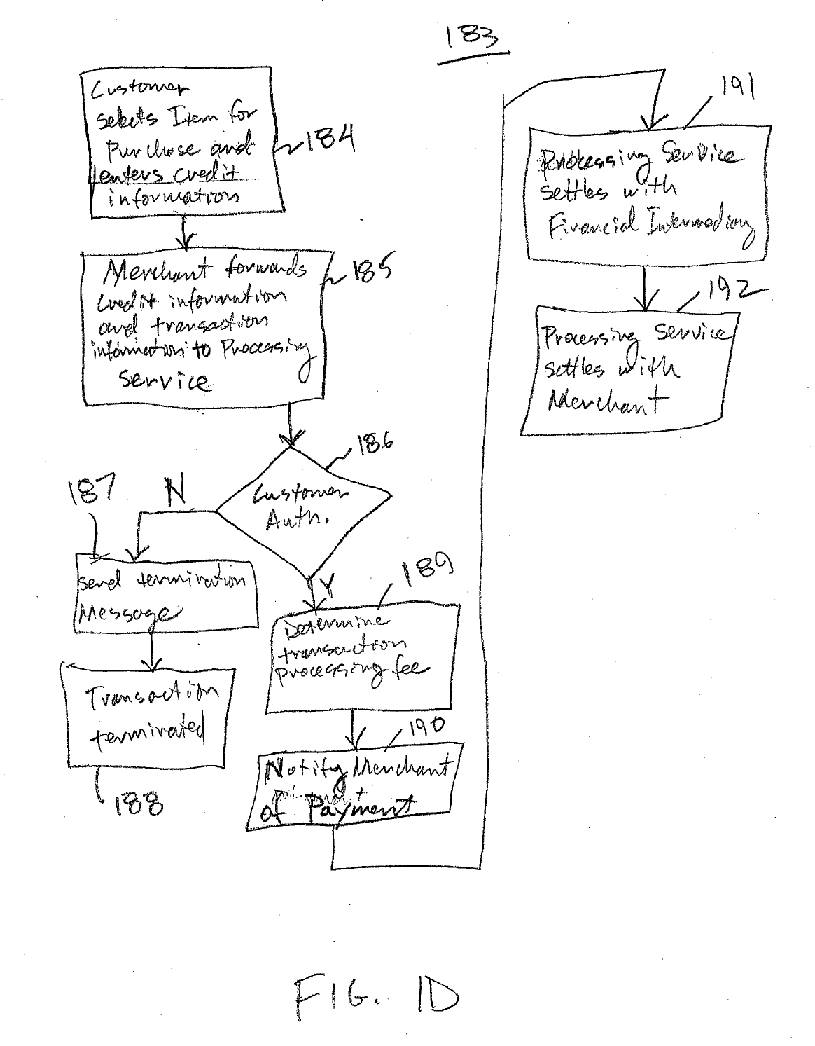

FIG. 1A shows a system 100 that may be used to process a non-cash transaction over a data communication network such as the Internet. Here, a customer 102 (e.g., a credit card holder) may use a computing platform to contact a web site operated by merchant 104 over the Internet. Customer 102 may make a shopping selection from the merchant's web site as shown through a message 108, and provide credit card information in a message 110. Here, message 110 may provide merchant 104 with a valid credit card number and related personal information, such as expiration date, shipping address, for example, in message 110.

Merchant 104 may receive the customer's personal credit information and contact the customer's credit card company 112 to charge the cost of the selected items through a message 114. If the charge against the credit card is successful, merchant 104 may be notified and forward an order confirmation 116 to customer 102. Merchant 104 may then ship goods to customer 102 and/or render a service to customer 102 in connection with a selection made through message 108. A short time later, card company 112 may make a payment to merchant 108 for the cost of the order through message 118. Finally, card company 112 may provide a bill to customer 102 for the cost of the purchase and any accrued interest charges through a message 120.

FIG. 1B shows a flow diagram illustrating processing of a non-cash transaction in a financial transaction system such as financial transaction system 100 illustrated above. Here, a customer may select a good and/or service for purchase from a merchant at block 152 and enter credit card information (e.g., to a merchant's website using a web browser) at block 154. Using credit card information entered at block 152, the merchant may query a financial intermediary such as a credit card company at block 156 to, for example, determine whether the financial intermediary would authorize the customer to complete the transaction at diamond 158 and determine whether the merchant is authorized to participate in the transaction at diamond 164. Diamond 158 may determine, for example, whether a customer has sufficient credit to complete the transaction. Diamond 164 may, for example, determine whether the merchant is in good standing with the financial intermediary.

If either test at diamonds 158 and 164 fail, block 160 may provide a message to the merchant indicating that the non-cash transaction cannot be processed. Such a message may also include a reason as to why the transaction cannot be processed such as, for example, that the customer does not have sufficient credit or that the merchant is not it good standing. However, these are merely examples of messages that may be provided to a merchant if a transaction cannot be processed, and claimed subject matter is not limited in this respect. Once such a message is sent, the non-cash transaction may terminate at block 162 before it completes.

If both tests at diamonds 158 and 164 succeed, a financial intermediary may dynamically determine a processing fee to be assessed for completing the transaction based on one or more factors as discussed below. In one embodiment, such a processing fee may be assessed to a customer by adding a fee to the value of the non-cash transaction in an invoice to the customer for settling payment between the financial intermediary and the customer. Alternatively, such a processing fee may be assessed to a merchant by, for example, setting off a transaction processing fee from an amount to be paid by the financial intermediary to the merchant for settling the non-cash transaction. In yet another embodiment, a first portion of a transaction processing fee may be assessed to a customer while a second portion of the transaction processing fee may be assessed to a merchant.

A financial intermediary may notify a merchant that the financial intermediary has made payment or agrees to make payment in the future at block 168. The merchant may then tender goods and/or services to a customer which are the subject of the non-cash transaction. The financial intermediary may also provide an invoice statement to a customer at block 170 for settling payment for financing the non-cash transaction.

As illustrated above according to a particular embodiment, a financial intermediary may dynamically determine a transaction processing fee to be assessed to a customer and/or a merchant at block 166 based on one or more factors. Accordingly, the parties are provided with flexibility in determining appropriate and cost effective methods of financing non-cash transactions.

In one embodiment, a financial intermediary may dynamically determine a fee for processing a non-cash transaction for a customer and/or merchant based, at least in part, upon a risk that the customer may default in payment to settle the non-cash transaction in the future. Such a risk may be determined, for example, from particular instances of non-payment or late payment for settling previous non-cash transactions with the financial intermediary, a credit history of the customer in connection with other parties in general, a running credit balance, assets owned by the customer and/or a demographic profile associated with the customer (e.g., age, gender, profession, employment history). However, these are merely examples of how a financial intermediary may determine a risk of a customer defaulting on payment to settle a non-cash transaction and claimed subject matter is not limited in these respects.

In another embodiment, a financial intermediary may dynamically determine a fee for processing a non-cash transaction for a customer and/or merchant based, at least in part on a particular transaction method used by a customer to initiate the transaction with the merchant. Different transaction methods may include, for example, a purchase made by entering order information to a merchant's website through a browser, telephone order (e.g., selecting items from a published catalog) and in-store purchase. However, these are merely examples of different transaction methods that a customer may use to initiate a non-cash transaction to purchase a good and/or service, and claimed subject matter is not limited in these respects.

In another embodiment, a financial intermediary may dynamically determine a fee for processing a non-cash transaction for a customer and/or merchant based, at least in part, on a frequency with which the customer has agreed to make payments to the financial intermediary for settling non-cash transactions. Here, for example, such a payment frequency may be associated with predetermined payment periods such as weekly, monthly and annual payment periods. However, these are merely examples of payment periods that may define a payment frequency for settling non-cash transactions and claimed subject matter is not limited in this respect.

In another embodiment, a financial intermediary may dynamically determine a fee for processing a non-cash transaction for a customer and/or merchant based, at least in part, on an allowable delay in payment. Such an allowable delay in payment may be determined, for example, a payment due date following a statement date. However, this is merely an example of an allowable delay in payment and claimed subject matter is not limited in this respect.

In another embodiment, a financial intermediary may dynamically determine a fee for processing a non-cash transaction for customer and/or merchant based, at least in part, on a predetermined volume agreement with the customer and/or merchant. Here,.for instance, a financial intermediary may assess a set fee for each of an initial number of non-cash transactions to a particular customer and/or merchant in a given period (e.g., a week or month). For transactions beyond the initial number of non-cash transactions in the given period, the financial intermediary may assess a flat fee or a fee comprising a gross percentage of an accumulation of the value of the additional non-cash transactions beyond the initial number of non-cash transactions. However, this is merely an example of how transaction processing fees may be assessed based, at least in part, on a predetermined volume agreement, and claimed subject matter is not limited in these respects.

According to a particular embodiment, although claimed subject matter is not limited in this respect, a financial intermediary may dynamically determine a transaction processing fee to be assessed to a customer and/or a merchant according to a predetermined schedule. Such a predetermined schedule may be negotiated between the financial intermediary and a customer or merchant before hand. Here, such a predetermined schedule may set out how a transaction processing fee may be selected based upon one or more factors.

According to a particular embodiment, although claimed subject matter is not limited in this respect, a predetermined schedule for determining a transaction processing fee may be accessible by a financial intermediary from a computing platform. Here, for example, such a schedule may be stored in a memory as one or more data structures and/or databases storing information to be used in determining a transaction processing fee based upon other information and events. As illustrated above, such a determination may be made in response to an event such as an attempt to complete a non-cash transaction to be financed by the financial intermediary. In one embodiment, financial intermediary may store in a database information relating to factor indicating a risk that the customer may default in payment to settle the non-cash transaction, a particular transaction method used by a customer to initiate the transaction with the merchant, a frequency with which the customer has agreed to make payments to the financial intermediary for settling non-cash transactions and an allowable delay in payment. In one alternative, a financial intermediary may receive at least some of this information from a customer and/or merchant requesting the financial intermediary to finance the non-cash transaction. In another alternative, a financial intermediary may receive at least some of this information in real-time from a third party service using, for example, a Web service. However, these are merely examples of how a computing platform may obtain information to determine a transaction processing fee according to a predetermined schedule and claimed subject matter is not limited in these respects.

Such a Web service as referred to above may integrate application programs hosted by a computing platform operated by financial intermediary 112 and application programs hosted by a computing platform operated by the third party service using an Internet protocol (IP) infrastructure. In particular examples, although claimed subject matter is not limited in these respects, such a Web service may employ standard communication protocols to transmit data objects among component applications over an Internet protocol such as, for example, HTTP, HTTPS, XML, SOAP, WSDL and/or UDDI standards. Here, XML may be used to tag data objects, SOAP may be used to transfer data objects, WSDL may be used to describe available services and UDDI may be used to list available services. However, these are merely examples of protocols that may enable a Web service and claimed subject matter is not limited in these respects.

FIG. 1C is a schematic diagram of a transaction processing system 171 employing a third party processing service 180 to process non-cash transactions according to a predefined schedule according to a particular embodiment. Here, processing service 180 and a merchant 174 may agree to an arrangement where processing service 180 processes non-cash transactions on behalf of merchant 174. In a particular embodiment, although claimed subject matter is not limited in this respect, processing service 180 may assess a fee for processing non-cash transactions on behalf of merchant 174 according to a predetermined schedule as illustrated above.

According to an embodiment, merchant 174 may allow customer 176 to purchase goods and/or services from merchant 174 on-line, using a website that is owned and operated by merchant 174 that is capable of communicating with a web browser hosted on a computing platform operated by customer 176, for example. Information regarding purchase selections and customer credit information received at the website may then be forwarded to processing service 180 for processing. In a particular embodiment, processing service 180 may arrange for payment to settle non-cash transactions with financial intermediary 172 (e.g., a card company extending credit to customer 176) and for payment to merchant 174 through, for example, an Automatic Clearing House (ACH, not shown) to permit bank-to-bank transmission of funds to pay for merchant goods and/or services.

While financial transaction system shows a single financial intermediary 172, it should be understood that more than one such financial intermediary may be available finance a non-cash transaction on behalf of customer 176. In a particular embodiment, processing service 180 may make arrangements with two or more banks and/or credit card companies capable of financing a non-cash transaction on behalf of customer 176. Credit information entered by customer 176, and forwarded to processing service 180, may then be used to select a particular financial intermediary to finance the non-cash transaction.

FIG. 1D is a flow diagram illustrating a process to enabling a service to process non-cash transactions on behalf of a merchant according to an embodiment of a transaction processing system such as transaction processing system 171, for example. At block 184, a customer may browse a merchant's website and make a selection to purchase one or more items, and enter credit information. Such credit information may include, for example, a credit number or other information associating the customer with a credit account. In the particular embodiment of financial transaction system 171, for example, customer 176 may browse a website operated by merchant 174 as illustrated by message 178 and select an item for purchase as illustrated by message 179.

In a particular embodiment, although claimed subject matter is not limited in this respect, information may be exchanged between merchant 174 and processing service 180 using a web service linking a website operated by merchant 174 and one or more applications hosted on a computing platform operated by processing service 180 to process non-cash transactions. In the particular embodiment of financial transaction system 171, for example, communications employed in a web service may be represented as messages 175 and 194. At block 185, a merchant may forward at least some of the credit information entered by a customer and information regarding the non-cash transaction to be processed such as, for example, a value associated with the non-cash transaction. This may be represented as message 194 in the particular embodiment of financial transaction system 171.

At diamond 186, a processing service may determine whether a customer is authorized to complete a non-cash transaction initiated at block 184. Here, for example, such a processing service may determine whether the customer has sufficient credit. In the particular embodiment of financial transaction system 171, financial intermediary 172 may establish a credit account on behalf of customer 176. Processing service 180 may query financial intermediary 172, illustrated by message 173, to determine whether customer 176 has sufficient credit, as provided in a response in message 181.

If a customer is not authorized to complete a non-cash transaction at diamond 186, a processing service may initiate transmission of a message to a merchant indicating that the processing service will not process the non-cash transaction at block 187. Alternatively, the merchant and/or processing service may provide alternatives to the customer for financing the non-cash transaction such as, for example, specifying a different financial intermediary and/or credit account.

If a customer is authorized to complete a non-cash transaction at block 186, a processing service may determine a transaction processing fee at block 189 using one or more of the techniques illustrated above. In the particular embodiment of financial transaction system 171, for example, such an authorization may be provided in message 175.

According to a particular embodiment, although claimed subject matter is not limited in these respects, a merchant may operate a website enabling customers to purchase items (e.g., on-line content such as audio content, video content and documents) while a processing service assess a processing fee to the merchant. In the particular embodiment of financial transaction system 171, for example, processing service 180 may determine a processing fee to be assessed to merchant 174 at block 189 according to a predetermined schedule (e.g., negotiated between merchant 174 and processing service 180 before hand). Over a predetermined period, for example, processing service 180 may assess a fixed fee for each non-cash transaction completed using the processing service 180 up to a set value of accumulated transactions. For transactions beyond the set value of accumulated transactions in the predetermined period, for example, processing service 180 may assess a percentage of a value of gross receipts for transactions beyond the set value. This percentage may be lowered, for example, if merchant 174 is willing to accept delayed payment or raised, for example, if merchant 174 demands immediate payment. In another embodiment, merchant 174 may negotiate with processing service 180 to pay lower processing fee in exchange for accepting scheduled fixed dollar payments to settle a non-cash transaction, as opposed to an immediate lump sum. Here, in a particular numerical example for purposes of illustration, merchant 174 may agree to be paid $10,000 per month for a term of two years from processing service 180 and/or financial intermediary 172. This would be true knowing that the goods sold for any given month would likely be higher or lower than $10,000 for any given month.

However, this is merely an example of how a processing service and a merchant may arrange for determining fees for processing non-cash transactions according to a particular embodiment and claimed subject matter is not limited in these respects.

At block 190, a processing service may notify a merchant that the processing service will process a non-cash transaction for payment. Such a notification may include, for example, a transaction processing fee that would be assessed to the merchant for processing the non-cash transaction. In the particular embodiment of financial transaction system 171, for example, such a notification may be provided in message 175. Following such notification, merchant 174 may then enable customer 176 to complete the transaction to purchase items selected at block 184.

At block 191, a processing service may settle with a financial intermediary for payment to finance a non-cash transaction. In the particular embodiment of financial transaction system 171, for example, this may be illustrated by an invoice in message 176 followed by a payment notification in message 169. At block 191, a processing service may settle with a merchant for financing one or more non-cash transactions by, for example providing payment to the merchant in response to an invoice using, for example, an ACH to allow bank-to-back transfers. In a particular embodiment, although claimed subject matter is not limited in this respect, such payment to a merchant may comprise a cumulative value associated with transactions processed by a processing service, offset by fees assessed by the processing service to process the non-cash transactions.

In an alternative embodiment, a financial transaction system may eliminate any need for the transmission of such confidential information outside the control of a customer. A merchant may participate in a financial transaction system by providing information about items to be purchased and by agreeing to be paid by the financial intermediary on behalf of the customer. As illustrated in U.S. Pat. No. 6,332,134 titled “Financial Transaction System,” one or more intermediaries may be involved in the processing of a non-cash transaction between a merchant and a customer in such a manner that the merchant does not need access to the customer's sensitive financial information and/or other personal information to complete the transaction. Here, a customer and a merchant may agree on terms of a proposed non-cash transaction to purchase a good and/or service to be financed through, for example, a credit card or debit card transaction. The customer may then forward information regarding the transaction to a financial intermediary (e.g., a credit card company). The financial intermediary may then forward a payment notification to the merchant to complete the non-cash transaction. The merchant may then provide the goods and/or services, and the financial intermediary and the customer may settle accounts following the purchase.

According to an embodiment, a customer may register with a financial transaction system by contacting a financial intermediary and requesting that one or more of the customer's accounts be available for use in the financial transaction system. During such customer registration, a customer may receive software to install on the customer's computing platform. Such software may contain, for example, code and/or information that can be recognized by a registered merchant's website that allows a purchase using the financial transaction system. Such software may contain a changeable user password, a customer ID, a “Sales Log” database, dialing software, instructions, off-line catalog sites, and any miscellaneous promotions and/or data. A customer may load such software on his or her computing platform and follow step by step instructions culminating in clicking on a “Register Now” button on a graphical user interface (GUI), for example. Executing the software, the computing platform may then contact the financial intermediary by, for example, dialing the financial intermediary's toll free number (e.g., using the computing platform's phone modem) or through other on-line means (e.g., Internet protocol over a broadband modem). Following such contact of the financial intermediary, a registration process may be conducted. Here, according to a particular embodiment, a customer's ID and password may be checked against the financial intermediary's records. At registration, a different password may be chosen. For example, in one particular embodiment, multiple customer IDs and passwords can be assigned to the same card and/or account number.

An Order Verification Reply Target (OVRT) may be provided by the customer comprising information enabling a financial intermediary to address messages to the customer comprising order confirmations or other information. Such an OVRT may comprise, for example, a telephone number to receive voice and/or facsimile communications, an e-mail address, Universal Resource Locator (URL), domain name and/or the like to which real-time communications may be addressed. It should be understood, however, that these are merely examples of information that may be used for addressing messages to a customer regarding a transaction and claimed subject matter is not limited in these respects. It may also be possible for the customer to register by voice over the telephone, fax or mail, however, installing computer software on customer's computing platform allows the customer to use the financial transaction system when making purchases over data networks, like the Internet.

A merchant may register with the financial intermediary to use a financial transaction system to become authorized to accept payment for providing goods and/or services in transactions with customers. For example, the financial intermediary and merchant may agree to use an ACH to allow bank-to-bank transmission of funds to pay for merchant goods. Thus, a merchant's invoice may be satisfied when the financial intermediary transfers funds to the ACH and then notifies the merchant of the transfer.

According to an embodiment, a merchant may also register with a financial transaction system by installing software to a computing platform for recognizing consumers browsing a website using software installed on the consumers' computing platform identifying (as illustrated below) such consumers as being registered to the financial transaction system. Upon such registration, a merchant may receive a database enabling processing of non-Internet orders from consumers using off-line catalogs. Also, such a merchant may also receive unique identifier (ID) that is contained within the computer software installed to the merchant's computing platform. It should be understood, however, that these are merely examples of software that may be installed on a merchant's computing platform, and claimed subject matter is not limited in these respects.

As illustrated above, a customer may provide an OVRT to enable a financial intermediary to notify a customer of the status of orders and/or other information. Here, for example, a financial intermediary may notify a customer of a completion or termination of a transaction, and any problems that may have arisen in the course of the transaction, by associating the customer its OVRT. Such notification may be in the form of an automated reply via email or other Internet protocol, fax and/or a voice message, for example. A merchant may also be associated with an OVRT to the financial intermediary to receive information relating to customer purchases. In one particular embodiment, although claimed subject matter is not limited in these respects, an OVRT may be associated with an Internet Protocol (IP) address and/or Internet domain name. However, these are merely examples of how an OVRT may be implemented and claimed subject matter is not limited in these respects.

During customer registration, a shipping address for the customer may be provided. Such a shipping address may indicate where items that are purchased by the customer are to be shipped. This can be different from a customer's billing address. The billing address may indicate where the financial intermediary should send bills relating to the customer's credit account. According to an embodiment, a financial transaction system may allow, by use of authentication using a password and User ID for example, one or more alternative addresses to be used for specific purchases. This may overcome a problem of having a billing address that is different from the shipping address. For example, a P.O. Box may be used, or some other temporary address, so that for instance, a customer may purchase airline tickets while traveling or when making a purchase to send to another address as a gift.

According to an embodiment, a history of purchases made by a customer using a financial transaction system may be maintained in a database stored on a computing platform operated by the customer. This may allow such a customer the convenience of determining information about what has been purchased, vender, price, etc. Also, the data may be maintained in a format (e.g., data fields separated by tab or comma) that may be exportable to record keeping software such as Quicken, Excel, FileMaker Pro or any program that accepts data in such a format.

As discussed above, customers and merchants may register to obtain an ID and password to be used in participating in the financial transaction system. Software installed on a customer's computing platform may operate in conjunction with well known browser programs to allow the customer to browse the Internet and make purchases using the financial transaction system. Such installed software may include one or more of the following modules and/or items of information:

plugins covering typical operating systems and browsers;

registration routine (as illustrated above);

routine for maintaining database logging purchases for the customer's use;

instructions for registration;

dialing string software for initial registration to a direct toll free line;

IP address, URL and/or domain name for use in contacting financial intermediary for registration;

offline website/catalogs featuring financial intermediary merchants;

credit card application for the financial intermediary;

applications to register with shipping companies; and

browser(s) which is adapted to dial direct any of the selected merchants via a toll free offline number.

FIG. 1E is a schematic diagram of a financial transaction system 200 according to an embodiment. In a particular embodiment, although claimed subject matter is not limited in this respect, a financial intermediary 202 (such as a credit card company, for example), merchant 206 and customer 204 may operate and/or control computing platforms that are capable of communicating with one another over a communication network such as the Internet, for example. As discussed above, financial intermediary 202 may provide software to customer 204 to be loaded to its computing platform for implementing features of a financial transaction system. This may allow customer 204 to conduct financial transactions over the Internet or other data network, for example. Financial intermediary 202 may also authorize a subscribing merchant 206 to utilize the financial transaction system and issue software to merchant 206 for use in conjunction with merchant's interface to financial transaction system 200 including, for example, a website. Here, merchant 206 may agree to accept payment from financial intermediary 202 via an ACH 222, which may perform bank to bank transfers for example. Once the software is installed on computing platforms of both customer 204 and merchant 206, a financial transaction may be conducted as illustrated above.

The description below illustrates interactions between a customer's computing platform and a merchant's computing platform as inputs provided by the customer to a GUI on customer's computing platform which are received at a website operated and/or controlled by the merchant according to an HTTP protocol. Alternatively, however, computing platforms operated and/or controlled by a merchant and a customer may employ any one of several techniques to communicate such as, for example, dial-up modem-to-modem communication over phone lines, a Web service, email and/or other protocols supported by the Internet protocol. It should be understood, however, that these are merely examples, of how a customer's computing platform may communicate with a merchant's computing platform and claimed subject matter is not limited in this respect.

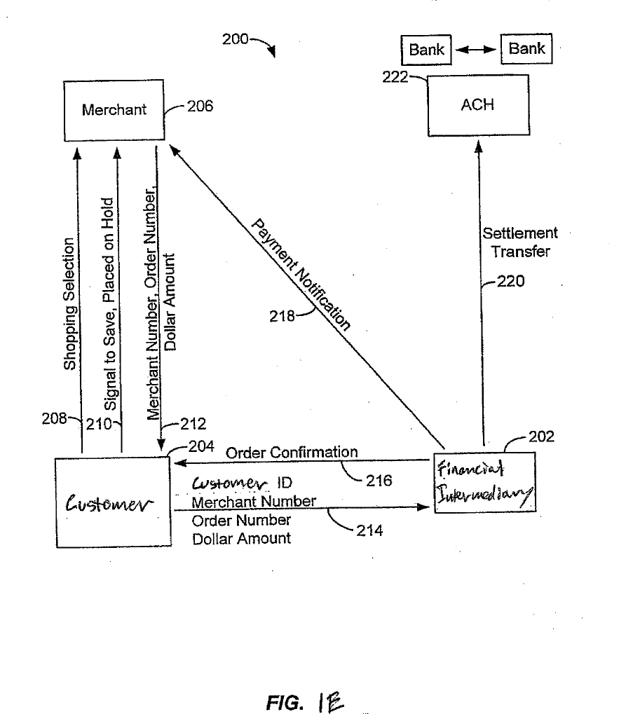

As illustrated below according to particular embodiments, a fee for processing a non-cash transaction between customer 204 and merchant 206 may be determined dynamically. FIG. 2 is a flow diagram illustrating a process 300 of conducting a financial transaction using financial transaction system 200, for example, to enable secure financial transactions among customer 204, merchant 206 and financial intermediary 202. At block 302, a customer may make a selection of a good and/or service to purchase from a merchant by, for example, browsing the Internet using a browser program to select a good and/or service from the merchant's website as shown by a message 208. In one embodiment, as pointed out above, software loaded to a customer's computing platform may operate as a plug-in for such a browser. According to an embodiment, a customer may communicate with a merchant's website, which may be in communication with software installed on the merchant's computing platform and provided by a financial intermediary as illustrated above. Here, the merchant's website may recognize the customer's browser software, and thus identify the customer as a member of and/or participant in an associated financial transaction system. For example, in one embodiment, the customer's browser may transmit special codes and/or information upon entering the merchant's website. Such codes and/or information may be interpreted by the software installed on the merchant's computing platform to determine that the customer is registered with the financial transaction system. In another embodiment, the merchant's computing platform may transmit special codes and/or information to a customer's computing platform, which can be interpreted at the customer's computing platform. The customer's computing platform may then respond to the merchant's system, resulting in both computing platforms acknowledging membership in the financial transaction system.

According to an embodiment, a merchant's website may provide a virtual shopping cart to maintain a record of selections made by customers. At some point, a customer may desire to purchase the items in the shopping cart, and click on a “button” on a GUI, for example, which may read, “pay by financial transaction system,” for example. In the particular embodiment of financial transaction system 200, this may be represented as message 210.

At block 304, a merchant's computing platform may save order information regarding customer selection(s) made at block 302 and create a purchase order containing the merchant's ID, a unique order number for the purchase, a dollar amount for the purchase, and identification data such as the merchant's email address, domain name, etc. The purchase order may then be transmitted to the customer's computing platform and stored in a database on the customer's computing platform as shown by message 212 in the particular embodiment of financial transaction system 200. In essence, although not necessarily in all embodiments, such a purchase order may act as a merchant's offer to sell the selected good and/or service to a customer. In alternative embodiments, however, receipt of such a purchase order does not necessarily constitute a legal “offer” to form a binding contract.

In a particular embodiment, a customer's browser may “tickle” a merchant Website to keep an Internet session active. In the meantime, the customer's browser may transmit a request to pay (RTP) to the financial intermediary's system at block 306 as shown by message 214 in the particular embodiment of financial transaction system 200. Here such an RTP may include a purchase order data from the merchant and the customer's unique ID and password. At diamonds 308 and 310, the RTP and the purchase order may be processed by a financial intermediary. Here, a computing platform may perform two tests. A first test, at block 308, may determine whether the customer is authorized to make the requested purchase. For example, it is determined whether the customer has enough credit available to pay for the selected items. A second test, at block 310, may determine whether the merchant is authorized to participate in this transaction. For example, is the merchant a registered merchant in good standing.

At block 312, if either test fails, the financial transaction system may reply to the predetermined OVRT addresses with an appropriate message for both merchant and customer. For example, one message may go to the customer to state that there is not enough credit available to make the requested purchase. A second message may go to the merchant to state that the customer is unable to complete the transaction. The merchant may also receive a message indicating that the transaction was terminated since the merchant is not a member of the financial transaction system. The merchant's OVRT may be provided during merchant registration or included in the purchase order information sent to the financial intermediary. Once the messages are sent, the transaction is terminated as shown at block 314.

If both tests at diamonds 308 and 312 pass, at block 316 a financial intermediary may determine a transaction processing fee for the non-cash transaction to be assessed to the customer and/or merchant, and reply to predetermined OVRT addresses with an appropriate message to both customer and merchant. Here, a financial intermediary may determine a transaction processing fee to be assessed to a customer and/or merchant using any of the aforementioned methods for dynamically determining a processing fee for a non-cash transaction. Without belaboring the discussion, such a transaction processing fee may be based, at least in part, on a risk that the customer may default in payment to settle the non-cash transaction in the future, a predetermined volume agreement with the customer and/or merchant, on a particular transaction method used by a customer to initiate the transaction with the merchant, a frequency with which the customer has agreed to make payments to the financial intermediary for settling non-cash transactions. Further, such a transaction processing fee may also be determined according to a predetermined schedule as illustrated above.

In yet another embodiment, a merchant may elect to be assessed a “Lowest Fee” for transactions occurring between calendar dates, or for transactions occurring over a set number of days in the future, for example. Here, if such a merchant's operations are not impaired by cash flow over such a period, the merchant may tolerate deferred payment from a financial intermediary to settle non-cash transactions in exchange for lower processing fees. Likewise, a financial intermediary may offer deferred payment to a merchant for settling non-cash transactions in exchange for a lower processing fee when, for example, the financial intermediary seeks to improve its cash flow. In either case, a customer need not be directly impacted.

Following determination of a transaction processing fee at block 316, a financial intermediary may transmit messages to a customer and/or merchant at block 318. In the particular embodiment of financial transaction system 200, for example, such messages may comprise a message 218 to merchant 206 and a message 216 to customer 204. particular embodiments, although claimed subject matter is not limited in this respect, message 216 may comprise an order confirmation number or other indication that the order is to be placed while message 218 may include a unique order number and a pre-registered shipping address or an authorized alternate shipping address. In addition, and to the extent to which a transaction processing fee is assessed to a customer or a merchant, such messages 216 and/or 218 may also indicate a fee being assessed for processing the non-cash transaction (e.g., as a set off from payment to merchant 206 or a markup to the invoice to customer 204). Financial intermediary 202 may also notify merchant 206 that payment has been made to ACH 222 to be used in transferring funds between financial intermediary 202 and merchant 206.

At block 320, a merchant may match order information contained in a received OVRT with order information contained in a database maintained by the merchant. If the information matches, the merchant may ship the order to a specified address. In an alternative embodiment, a merchant may not have access to address information associated with a destination of a customer's purchased goods. Here, a shipping party (not shown) may merely receive goods from the merchant with order information. The shipping party may then associate the order information with location to deliver the purchased goods.

In an alternative embodiment, the merchant may not have access to address information associated with a destination of a customer's purchased goods. Here, a shipping party (not shown) may merely receive goods from the merchant with order information. The shipping party may then associated the order information with location to deliver the purchased goods.

At block 322, a financial intermediary may collect payment from a customer and forward payment to a merchant via a settlement transfer to an ACH. In the particular embodiment of financial transaction system 200, for example, this may entail financial intermediary 202 initiating a transfer of funds to merchant 206 via a message 220. As discussed above, financial intermediary 202 may assess a transaction processing fee to merchant 206 as a set off from an amount being paid by customer 204.

As a result of performing a financial transaction in accordance with process 300, a customer's credit card number or other personal information need not be transmitted over a computer network. This prevents theft of the customer's personal information. An additional level of security is provided since the merchant never has access to the credit card number or other personal information. Therefore, corruption or lack of security at the merchant's site may have no effect on the security of the customer's personal information.

Transfer of funds from the financial intermediary to the merchant may be performed using any one of several methods of transferring funds. In the above embodiment, the transfer occurred using an ACH. Since the transfer of funds is secondary, claimed subject matter is not limited in this respect as it is possible to transfer funds in other ways by, for example, wiring funds directly to a merchant's account.

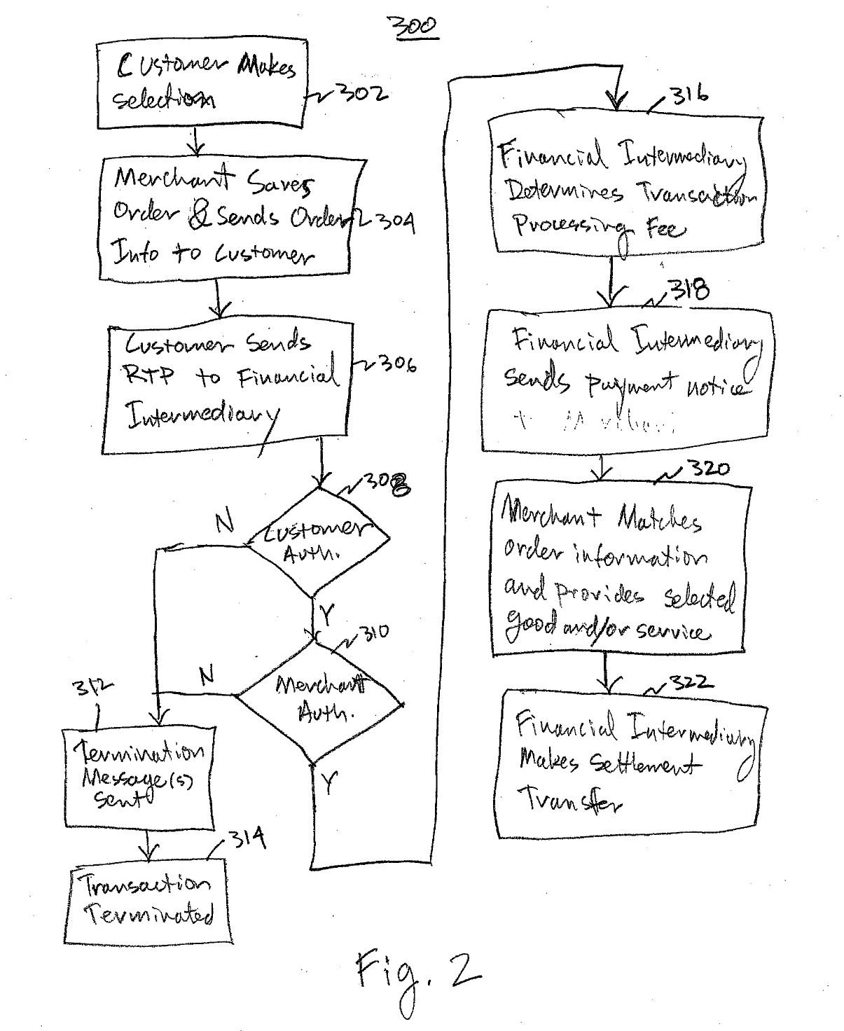

In another embodiment, although claimed subject matter is not limited in this respect, an invoice paying system is provided wherein a customer can make payments to merchants and/or service providers and/or other entities registered with a financial transaction system. FIG. 3 shows an invoice paying system 400 (or bill paying system) for paying invoices for goods and/or services in accordance with an embodiment. System 400 may allow a customer 402 to pay an invoice from a merchant 404 via a financial intermediary 406. As illustrated above in financial transaction system 200 with reference to FIG. 1C, financial intermediary 406 may dynamically determine a fee for processing a non-cash transaction to be assessed to customer 402 and/or merchant 404.

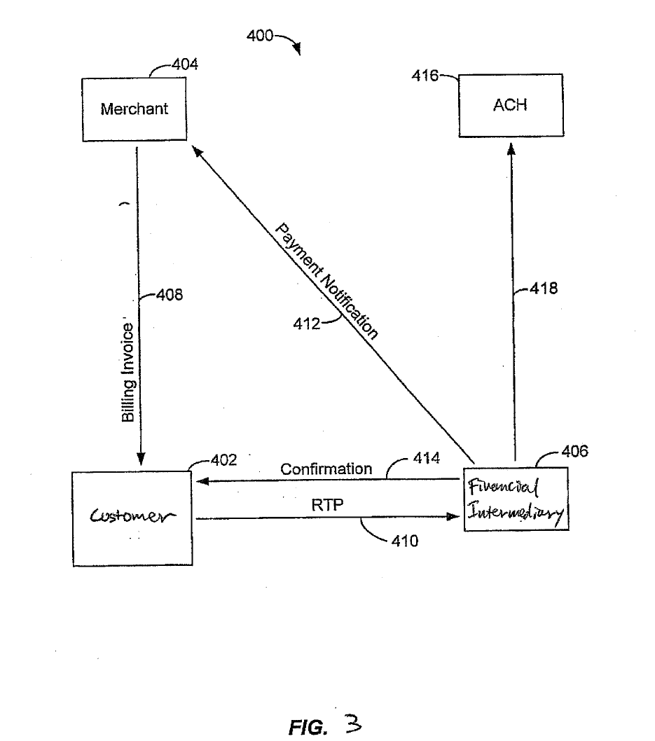

FIG. 4 is a flow diagram illustrating a process 500 for conducting a financial transaction for use with an invoice paying system such as invoice paying system 400 shown in FIG. 3, for example. Here, a merchant and customer may be registered with the financial transaction system as illustrated above.

At block 502, a customer may receive an invoice for goods and/or services from a merchant. Such an invoice may be received via electronic means, such as email, Web service or as a delivered hardcopy and may contain the merchant's ID number along with other relevant billing information. In the particular embodiment of invoice paying system 400 this may be shown as communication 408, for example.

At block 504, a customer may enter a merchant's ID information and billing information into his or her own computing platform having software for an invoice paying system as discussed above. At block 506, a customer may transmit a message containing this information to a financial intermediary along with an RTP. In the particular embodiment of invoice paying system 400, for example, such information with an RTP may be transmitted to financial intermediary 406 in a message 410. At diamond 508, financial intermediary may determine whether a customer is authorized to pay invoices. In the particular embodiment of invoice paying system 400, for example, this may entail determining whether customer 402 has sufficient credit available in a credit account to pay a merchant invoice identified in such an RTP. At diamond 510, a financial intermediary may verify that a merchant is authorized to receive payments. In the particular embodiment of invoice paying system 400, for example, this may entail determining whether merchant 404 financial intermediary 406 is registered with invoice paying system financial transaction system 400 and is eligible to receive payments accordingly.

At block 512, if the checks performed at diamonds 508 and 510 fail, then a message may be sent to the customer indicating that the invoice cannot be paid by the financial transaction system. The transaction may then be terminated as shown at block 514. A message need not be sent to merchant 404 since merchant 404 may not even be aware that customer 402 is attempting to pay the invoice via the financial transaction system.

At diamond 510, if the checks performed at diamonds 508 and 510 pass, as illustrated above according to particular embodiments, a financial intermediary may determine a transaction processing fee for the non-cash transaction to be assessed to the customer and/or merchant at block 516, and reply to predetermined OVRT addresses with an appropriate message to both the customer and the merchant at block 518. Again, a financial intermediary may determine a transaction processing fee to be assessed to a customer and/or merchant using any of the aforementioned methods for dynamically determining a processing fee for a non-cash transaction. Without belaboring the discussion, such a transaction processing fee may be based, at least in part, on a risk that the customer may default in payment to settle the non-cash transaction in the future, a predetermined volume agreement with the customer and/or merchant, on a particular transaction method used by a customer to initiate the transaction with the merchant, a frequency with which the customer has agreed to make payments to the financial intermediary for settling non-cash transactions. Further, such a transaction processing fee may also be determined according to a predetermined schedule as illustrated above. In the particular embodiment of invoice paying system 400, for example, financial intermediary 406 may then transfer funds to ACH 416 as agreed to by merchant 404 and financial intermediary 406 as initiated by message 418. Customer 402 may then record in a payment log that the invoice has been paid. Merchant 404 may then send purchased items to customer 402 which may include an account statement.

In business situations, the invoice paying system may allow a customer to make repeat orders or orders as needed, rather than having to cancel a standing automatic recurring system order. Professional services that don't have a website, for example, but wish to take credit card payments, can do so using the invoice paying system described herein. For example, if a customer obtains a service provider's ID number associated with an invoice paying system and invoice information from a bill mailed to the customer, the customer can still arrange for payments to be made via the financial transaction system with notification sent to the merchant via telephone, e-mail, a Web service, mail or fax systems.

According to an embodiment, although claimed subject matter is not limited in this respect a financial transaction system may provide for purchasing goods and/or services from catalogs published by merchants. Such catalogs may be in the form of hardcopy, electronically downloaded merchant catalogs or web pages. Thus, a purchaser can view the catalog information in an off-line mode, i.e. when not connected to a merchant's website, and purchase selected goods or services. When downloaded as web pages, the catalogs may be fully functional and operate in the same manner as if the customer was connected on-line to the merchant's website.

FIG. 5 is a schematic diagram of a financial transaction system 600 for purchasing goods and services off-line according to an embodiment. A merchant 602 provides catalog information 601 about available goods and/or services to a customer 604. Customer 604 may make purchases from the catalog 601 using a financial transaction system provided by financial intermediary 606, for example. An ACH 622 may make bank to bank transfers allowing financial intermediary 606 to transfer funds to merchant 602 on behalf of customer 604. As illustrated above in financial transaction system 200 with reference to FIG. 1C and in invoice paying system 400 with reference to FIG. 3, financial intermediary 606 may dynamically determine a transaction processing fee to be assessed to customer 604 and/or merchant 602.

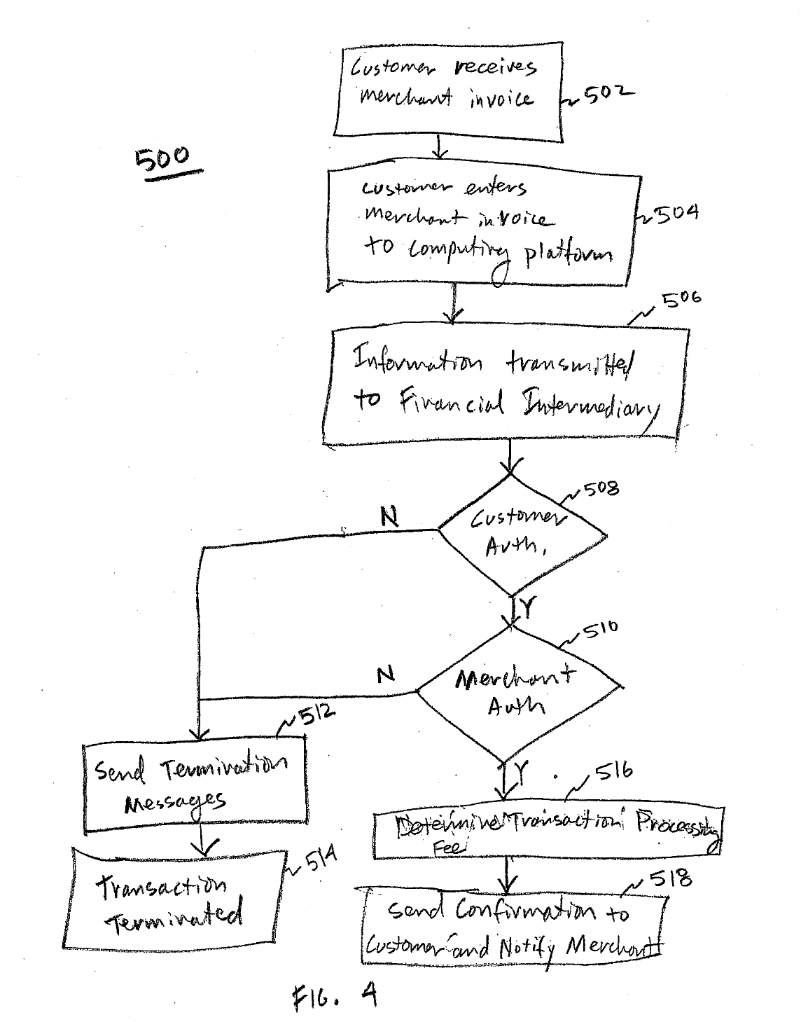

FIG. 6 is a flow diagram illustrating a process 700 for conducting a financial transaction for the purchase of a good and/or service off-line. In a particular embodiment, this may be accomplished using financial transaction system 600. At block 702, a customer may review a merchant's catalog (e.g., a hardcopy or electronic catalog) and select items for purchase. In the particular embodiment of financial transaction system 600, this may be provided to customer 604 through communication 608 in any one of several forms such as, for example, a hardcopy catalog to the customer via regular mail, other mail delivery, facsimile service and/or the like. Merchant 602 may also transmit a softcopy of catalog 601 to customer 604's computing platform via email and/or other electronic transmission means. It some embodiments, customer 604 may communicate with a website being operated by merchant 602 to selectably download catalog 601 from the merchant's website to the customer 604's computing platform for later viewing. Catalog 601 may also comprise an off-line version of a website operated by merchant 602. It should be understood, however, that these are merely examples of how a customer may obtain a version of a catalog and claimed subject matter is not limited in this respect.

According to an embodiment, a merchant's catalog may include information identifying goods and/or services offered by the merchant, prices associated with such goods and/or services, related shipping services available, other costs and/or the like. In the particular embodiment of the financial transaction system 600, catalog 601 may also comprise an ID associated with merchant 602 as a participant in a financial transaction system and other merchant profile information.

At block 702, a customer may review a merchant's catalog and select one or more items for purchase. In the particular embodiment of financial transaction system 600, for example, customer 604 may read a hardcopy version of catalog 601 when away from his or her computing platform, or may view an electronic version of catalog 601 on his or her computing platform when not connected to merchant 602's on-line system (e.g., through a website operated by merchant 602). While viewing an electronic version of catalog 601 off-line, according to an embodiment, customer 604 may select items for purchase and click on a “buy” button, from a GUI for example, to begin the purchase process. While viewing a hardcopy version of catalog 601, according to a different embodiment, customer 604 may select items for purchase and enter associated information to identify the selected items, the merchant 602's ID, a phone number to contact the merchant, and any other related information into software installed on customer's computing platform. Alternatively, customer 604 may make selections using other techniques such as placing an order with a telephone call center operated by merchant. It should be understood, however, that these are merely examples of how a customer may make a selection from a catalog and claimed subject matter is not limited in these respects.

At block 704, after a customer has made selections as illustrated above, a customer may, through his or her computing platform for example, contact a computing platform owned and/or operated by a merchant to place an order using one or more techniques illustrated above. In the particular embodiment of financial transaction system 600, for example, customer 604's computing platform may contact merchant 602 as shown by message 610. Merchant 602's computing platform may obtain purchase data from customer 604's computing platform, which may be in the form of delimited text for example, and store the received purchase data in a database. Optionally, the merchant 602's computing platform may check for inventory levels and/or price changes. If items are out of stock or there has been a price change, merchant 602's computing platform may reply to customer 604 to give customer 604 the option to revise the order or to proceed. Merchant 602 may have the option to terminate the order and prompt customer 604 to resubmit the order when the changes have been made or to maintain a communication session while customer 604 revises the order.

In another embodiment, when a “buy” button in a GUI of customer 604's computing platform is clicked on, the GUI may be directed to the merchant 602's website. Upon establishing communication between customer 604's computing platform and merchant 602's website, information exchanged between the merchant and the customer may be performed over the data network.

At block 706, a merchant may create a purchase order (PO) containing, for example, a merchant ID, a unique order number for the purchase, a dollar amount for the purchase price, and other data such as the merchant's email address, URL and/or the like. In the particular embodiment of financial transaction system 600, for example, the PO may be transmitted to the customer 604's computing platform in message 612, and stored in a database on the customer 604's computing platform.

At block 710, a customer may transmit a request to pay (RTP) to a financial intermediary. In the particular embodiment of financial transaction system 600, customer 604's computing platform may transmit an RTP to financial intermediary 606 in message 614 using one or more of the techniques illustrated above. Such an RTP may include purchase order data from merchant 602 and customer 604's ID and password. Alternatively, the RTP may also include other information, such as customer survey information, wherein the customer recommends other merchants that may be part of financial transaction system 600. However, this is merely an example information that may be provided in an RTP and how such an RTP may be transmitted to a financial intermediary, and claimed subject matter is not limited in these respects.

At block 710, a financial intermediary may determine whether the received RTP is from a customer that is authorized to participate in the transaction. In the particular embodiment of financial transaction system 600, for example, a computing platform operated by financial intermediary 606 may determine whether customer 604 is registered member of and/or participant in financial transaction system 600. Such a computing platform operated by financial intermediary 606, according to a particular embodiment, may also review information regarding the requested purchase and determine whether customer 604 has sufficient funds and/or credit to cover the cost of the requested items, for example.

At block 714, a financial intermediary may determine whether a merchant is authorized to participate in the transaction. In the particular embodiment of financial transaction system 600, for example, a computing platform operated by financial intermediary 606 may determine whether a merchant's ID in a received RTP belongs to a registered member of and/or participant in financial transaction system 600. Financial intermediary 606's computing platform may perform other checks on the merchant, such as checking customer service ratings, etc.

At block 714, if either customer 604 or merchant 602 fail checks performed in diamonds 710 and 712, then financial intermediary 606 may send a termination message to customer 604. Such a termination message may indicate to customer 604 why the requested transaction was terminated.

At block 720, if checks at both diamonds 712 and 714 pass, as illustrated above according to particular embodiments, a financial intermediary may determine a transaction processing fee for the non-cash transaction to be assessed to the customer and/or merchant. Again, a financial intermediary may determine a transaction processing fee to be assessed to a customer and/or merchant using any of the aforementioned methods for dynamically determining a processing fee for a non-cash transaction. Without belaboring the discussion, such a transaction processing fee may be based, at least in part, on a risk that the customer may default in payment to settle the non-cash transaction in the future, a predetermined volume agreement with the customer and/or merchant, on a particular transaction method used by a customer to initiate the transaction with the merchant, a frequency with which the customer has agreed to make payments to the financial intermediary for settling non-cash transactions. Further, such a transaction processing fee may also be determined according to a predetermined schedule as illustrated above.

At block 720, a financial intermediary may create a purchase order to transmit to the merchant. The purchase order may contain information about the items to be purchased such as, for example, shipping information and payment notification. Contemporaneously, the financial intermediary may transfer payment to the merchant. In the particular embodiment of financial transaction system 600, for example, financial intermediary 606 may initiate such a transfer of payment with ACH 620 via message 618.

At block 722, a financial intermediary may provide an order confirmation to inform a customer that an order has been placed. In the particular embodiment of financial transaction system 600, such a confirmation may be provided in message 620. At block 724, a merchant may ship the requested items to a customer at an address specified in the purchase order. In an alternative embodiment, and as illustrated above, a merchant may not have access to address information associated with a destination of a customer's purchased goods. Here, a shipping party (not shown) may merely receive goods from the merchant with order information. The shipping party may then associate the order information with location to deliver the purchased goods.

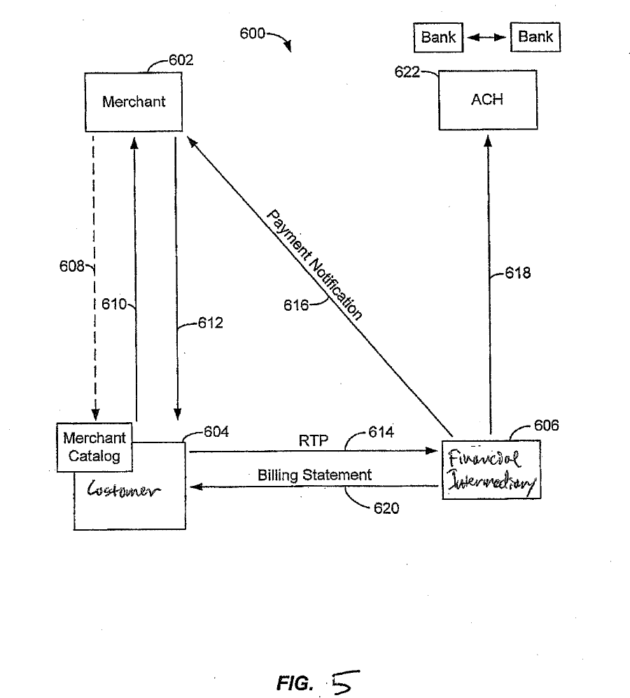

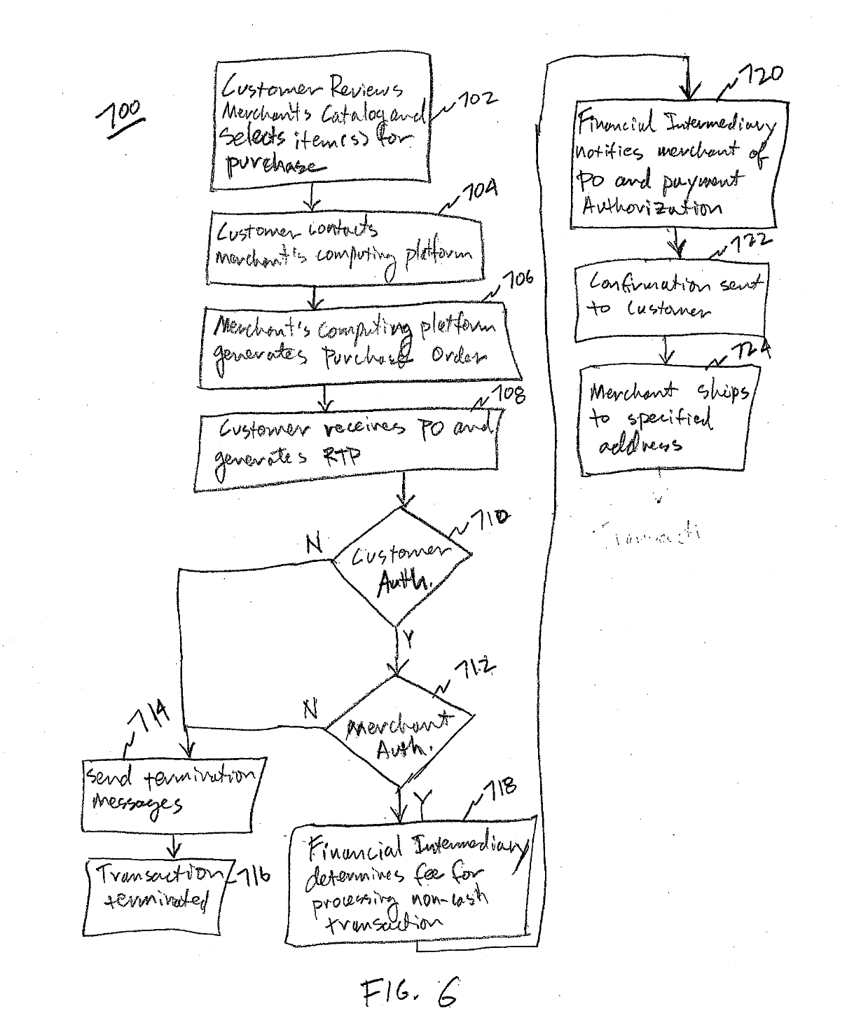

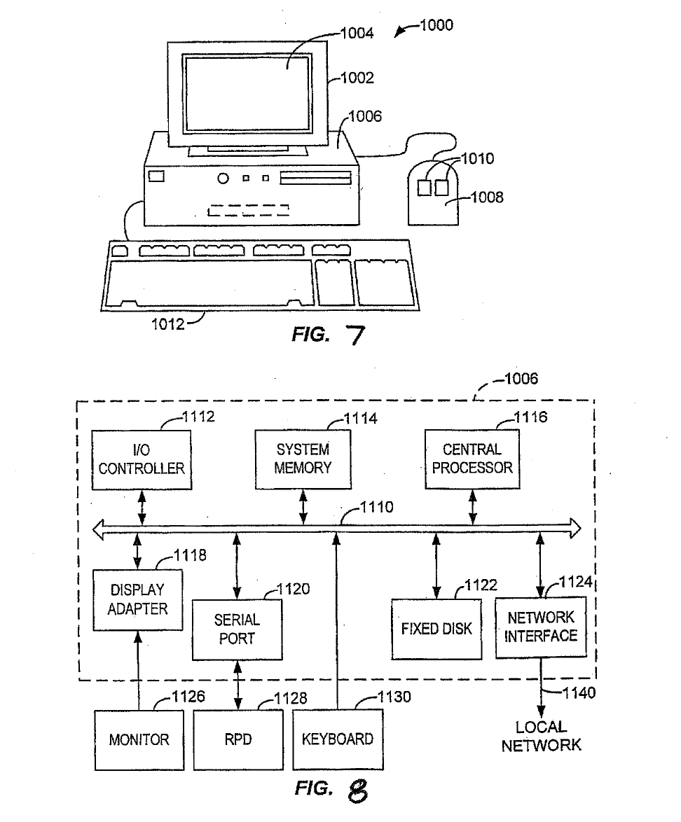

FIG. 7 is a schematic diagram of a computing platform 1000 suitable for use in embodiments of the financial transaction system. For example, such a computing platform may be operated by a customer, seller and/or financial intermediary to facilitate transactions as illustrated above. Here, computing platform 1000 may include display 1002 having display screen 1004, cabinet 1006 to house computer components (not shown) such as a disk drive, CDROM drive, display adapter, network card, random access memory (RAM), central processing unit (CPU), and other components, subsystems and devices, to name a few. User input devices such as a mouse 1008 having buttons 1010, and a keyboard 1012 are shown. Other user input devices such as a trackball, touch-screen, digitizing tablet, however, can be used. It should be understood that computing platform 1000 is merely illustrative of one particular type of computing platform, such as a desktop computer, suitable for use as illustrated above in connection with particular embodiments, and that other types of computing platforms may be used without deviating from claimed subject matter.

FIG. 8 is a schematic diagram of subsystems of a computing platform such as computing platform 1000 according to a particular embodiment. Subsystems within box 1006 may communicate via an internal bus 1110. Such subsystems may include input/output (I/O) controller 1112, random access memory (RAM) 1114, central processing unit (CPU) 1116, display adapter 1118, serial port 1120, fixed disk 1122 and network interface adapter 1124. Bus 1110 may allow subsystems to transfer data among the subsystems and with CPU 1116. External devices such as monitor 1126, relative pointing device (RPD) 1128 and keyboard 1130 may communicate with the CPU or other subsystems via bus 1110.

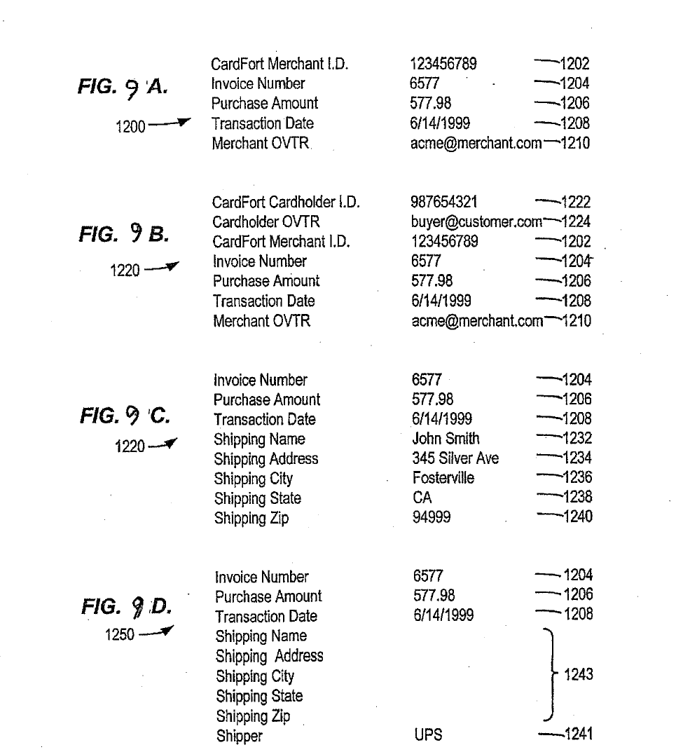

FIGS. 9A-9D show exemplary data formats which may be used during financial transactions described in the above embodiments.

FIG. 9A shows a data format 1200 for information transmitted from a merchant to a customer during operation of an embodiment of a financial transaction system as illustrated above. Data format 1200 includes a merchant ID 1202, an order number 1204, a purchase amount 1206, a transaction data 1208 and a merchant OVTR 1210. Other information in connection with a financial transaction may be included, however. Data format 1200 is intended to be an exemplary list of data items that may be transmitted from a merchant to a customer during operation of a financial transaction system, and claimed subject matter is not limited in this respect.

FIG. 9B shows a data format 1220 for information transmitted from a customer to a financial intermediary during operation of embodiments of a financial transaction system as illustrated above. Data format 1220 includes a customer ID 1222 and a customer OVTR 1224. Other information in connection with a financial transaction may be included, however. Data format 1220 is intended to be an exemplary list data items that may be transmitted from a customer to a financial intermediary during operation of a financial transaction system, and claimed subject matter is not limited in this respect.

FIG. 9C shows a data format 1230 for information transmitted from a financial intermediary to a merchant during operation of embodiments of a financial transaction system as illustrated above. Data format 1230 may include an order number 1204, purchase amount 1206 and transaction date 1208. Additional information such as a shipping name 1232, a shipping address 1234, a shipping state 1236, a shipping state 1238 and a shipping zip code 1240 may also be included. Other information in connection with a financial transaction may be included, however. Data format 1230 is intended to be an exemplary list of data items that may be transmitted from a financial intermediary to a merchant during operation of a financial transaction system, and claimed subject matter is not limited in these respects.

FIG. 9D shows a data format 1250 for information transmitted from a financial intermediary to a merchant during operation of embodiments of a financial transaction system as illustrated above. Data format 1250 may include an order number 1204, purchase amount 1206 and transaction date 1208. In a particular embodiment, information 1243, relating to a customer's shipping information, can be omitted so that such information given to the merchant only identifies the purchase that has been paid for. Data format 1250 may also include a shipper identifier 1241, so that the merchant is notified of a third party shipper that will handle shipping the purchase to the customer. The customer's shipping information may be given to the third party shipper and may be kept confidential from the merchant, for example. Other information relating to the financial transaction may be included, however. Data format 1250 is intended to be an exemplary list of data items that may be transmitted from a financial intermediary to a merchant during operation of a financial transaction system, and claimed subject matter is not limited in this respect.

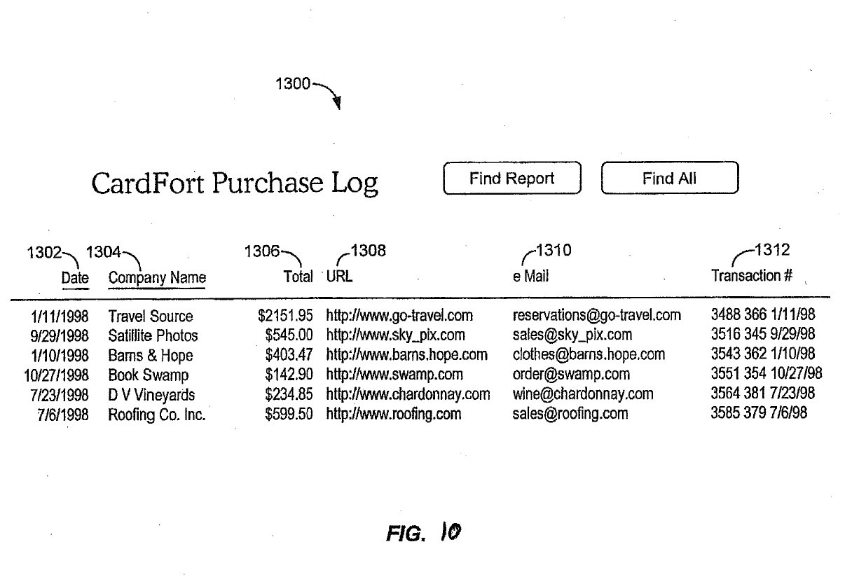

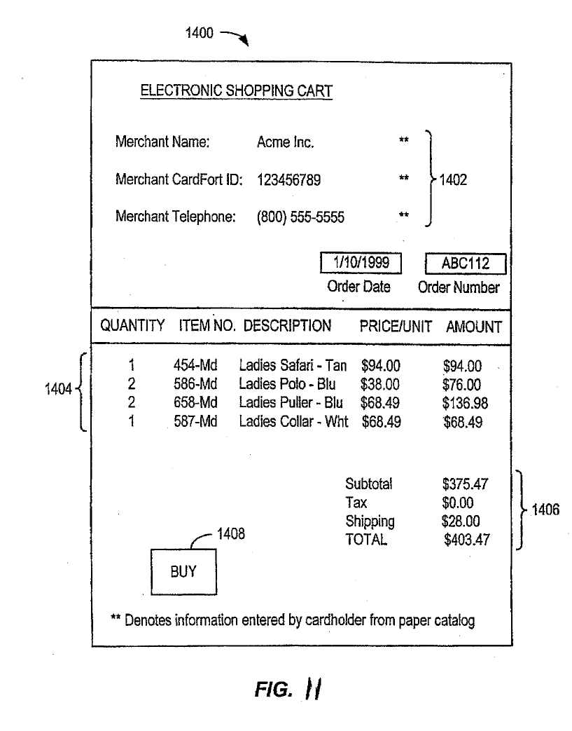

FIG. 10 shows an exemplary purchase log 1300 that may be employed with a financial transaction system as illustrated above and stored on a customer's computing platform. Purchase log 1300 includes a transaction date 1302, a merchant (company name) 1304 and a purchase amount 1306. Purchase log 1300 may also include a merchant URL 1308 or merchant email address 1310, which can be part of the merchant's OVRT. A transaction number 1312 may also be included in purchase log 1300 to enable a customer to reference a particular transaction by transaction number 1312. Other information relating to financial transactions may be included in a purchase log, however. Purchase log 1300 is intended to be an exemplary list of data items that may be included in a purchase log and claimed subject matter is not limited in these respects. A similar purchase log may be maintained by a merchant or financial intermediary. Thus, all parties to a particular transaction may maintain log information, and thereby store a history of financial transaction information.

FIG. 11 shows an exemplary electronic shopping cart 1400 which may be displayed in conjunction with a graphical user interface (GUI) of a computing platform operated by a customer. Here, electronic shopping cart 1400 may enable a customer to enter goods for purchase from a merchant. According to particular embodiments, although claimed subject matter is not limited in these respects, electronic shopping cart 1400 may be used in both on-line and off-line operating modes. For example, when a customer is connected to a merchant's web site, the merchant information, as shown at 1402, may be automatically inserted. If an off-line catalog electronic catalog from the merchant is used, the merchant information 1402 may also be automatically inserted. However, if a hardcopy of a merchant catalog is being used, the customer may manually enter merchant information 1402 into electronic shopping cart 1400.

As a selection is entered, item information, shown at 1404, may be entered into the electronic shopping cart. A total is provided at 1406. When the customer has completed making item selections, a buy button 1408, may be clicked on to start the financial transaction as provided in particular embodiments. Therefore, the electronic shopping cart 1400 can be used in both on-line and off-line applications to select item for purchase from a merchant and to activate a financial transaction in accordance with the present invention.

While there has been illustrated and described what are presently considered to be example embodiments, it will be understood by those skilled in the art that various other modifications may be made, and equivalents may be substituted, without departing from the claimed subject matter. Additionally, many modifications may be made to adapt a particular situation to the teachings of the claimed subject matter without departing from the central concept described herein. Therefore, it is intended that the claimed subject matter not be limited to the particular embodiments disclosed, but that the such claimed subject matter may also include all embodiments falling within the scope of the appended claims, and equivalents thereof.

What is claimed is:

1. A method comprising:
receiving a request for payment to settle a non-cash transaction;
dynamically determining a transaction processing fee associated with said non-cash transaction in response to said request.

2. The method of claim 1, and further comprising determining said transaction processing fee based, at least in part, on a risk of default associated with a customer initiating the non-cash transaction.

3. The method of claim 1, and further comprising determining said transaction processing fee based, at least in part, on a transaction method associated with said non-cash transaction.

4. The method of claim 1, and farther comprising determining said transaction processing fee based, at least in part, on a volume purchase agreement associated with said non-cash transaction.

5. The method of claim 1, and further comprising determining said transaction processing fee based, at least in part, on an allowable delay associated with payment to settle said non-cash transaction.

6. The method of claim 1, and further comprising determining said transaction processing fee based, at least in part, on a payment schedule associated with payment to settle said non-cash transaction.

7. The method of claim 1, wherein said receiving said payment request further comprises receiving said payment request from a customer initiating said non-cash transaction.

8. The method of claim 1, wherein said receiving said payment request further comprises receiving said payment request from a merchant.

9. The method of claim 1, and further comprising determining said transaction processing fee based, at least in part, on a pre-negotiated schedule.

10. The method of claim 1, and further comprising notifying a merchant of said determined transaction processing fee.

11. The method of claim 1, and further comprising receiving said payment request from a merchant, said non-cash transaction being initiated from a website operated by said merchant.

12. The method of claim 1, and further comprising assessing said transaction processing fee to a merchant as a set off of funds to be paid to merchant to settle said non-cash transaction.

13. The method of claim 1, and further comprising assessing said transaction processing fee to a customer to be combined with a value of said non-cash transaction in an invoice to said customer to settle said non-cash transaction.

14. An apparatus comprising:
a computing platform, the computing platform being adapted to:
receive a request for payment to settle a non-cash transaction;
dynamically determine a transaction processing fee associated with said non-cash transaction in response to said request.

15. The apparatus of claim 14, wherein said computing platform is further adapted to determine said transaction processing fee based, at least in part, on a risk of default associated with a customer initiating the non-cash transaction.

16. The apparatus of claim 14, wherein said computing platform is further adapted to determine said transaction processing fee based, at least in part, on a transaction method associated with said non-cash transaction.

17. The apparatus of claim 14, wherein said computing platform is further adapted to determine said transaction processing fee based, at least in part, on a volume purchase agreement associated with said non-cash transaction.

18. The apparatus of claim 14, wherein said computing platform is further adapted to determine said transaction processing fee based, at least in part, on an allowable delay associated with payment to settle said non-cash transaction.

19. The apparatus of claim 14, wherein said computing platform is further adapted to determine said transaction processing fee based, at least in part, on a payment schedule associated with payment to settle said non-cash transaction.

20. The apparatus of claim 14, wherein said computing platform is further adapted to receive said payment request from a customer initiating said non-cash transaction.

21. The apparatus of claim 14, wherein said computing platform is further adapted to receive said payment request from a merchant.

22. The apparatus of claim 14, wherein said computing platform is further adapted to determine said transaction processing fee based, at least in part, on a pre-negotiated schedule.

23. The apparatus of claim 14, wherein said computing platform is further adapted to notify a merchant of said determined transaction processing fee.

24. The apparatus of claim 14, wherein said computing platform is further adapted to receive said payment request from a merchant, said non-cash transaction being initiated from a website operated by said merchant.

25. The apparatus of claim 14, wherein said computing platform is further adapted to assess said transaction processing fee to a merchant as a set off of funds to be paid to merchant to settle said non-cash transaction.

26. The apparatus of claim 14, wherein said computing platform is further adapted to assess said transaction processing fee to a customer to be combined with a value of said non-cash transaction in an invoice to said customer to settle said non-cash transaction.

27. An article comprising:
a storage medium comprising machine-readable instructions stored thereon which, when executed, are adapted to cause a computing platform to:
dynamically determine a transaction processing fee associated with a non-cash transaction in response to receipt of a request for payment to settle said non-cash transaction.

28. The article of claim 27, wherein said instructions, when executed, are further adapted to cause said computing platform to determine said transaction processing fee based, at least in part, on a risk of default associated with a customer initiating the non-cash transaction.

29. The article of claim 27, wherein said instructions, when executed, are further adapted to cause said computing platform to determine said transaction processing fee based, at least in part, on a transaction method associated with said non-cash transaction.

30. The article of claim 27, wherein said instructions, when executed, are further adapted to cause said computing platform to determine said transaction processing fee based, at least in part, on a volume purchase agreement associated with said non-cash transaction.

31. The article of claim 27, wherein said instructions, when executed, are further adapted to cause said computing platform to determine said transaction processing fee based, at least in part, on an allowable delay associated with payment to settle said non-cash transaction.

32. The article of claim 27, wherein said instructions, when executed, are further adapted to cause said computing platform to determine said transaction processing fee based, at least in part, on a payment schedule associated with payment to settle said non-cash transaction.

33. The article of claim 27, wherein said payment request is received from a customer initiating said non-cash transaction.

34. The article of claim 27, wherein said payment request is received from a merchant.

35. The article of claim 27, wherein said computing platform is further adapted to determine said transaction processing fee based, at least in part, on a pre-negotiated schedule.

36. The article of claim 27, wherein said instructions, when executed, are further adapted to cause said computing to notify a merchant of said determined transaction processing fee.

37. The article of claim 27, wherein said payment request is received from a merchant, said non-cash transaction being initiated from a website operated by said merchant.

38. The article of claim 27, wherein said instructions, when executed, are further adapted to cause said computing platform to assess said transaction processing fee to a merchant as a set off of funds to be paid to merchant to settle said non-cash transaction.

39. The article of claim 27, wherein said instructions, when executed, are further adapted to cause said computing platform to assess said transaction processing fee to a customer to be combined with a value of said non-cash transaction in an invoice to said customer to settle said non-cash transaction.

40. A apparatus comprising:
means for receiving a request for payment to settle a non-cash transaction;
means for dynamically determining a transaction processing fee associated with said non-cash transaction in response to said request.

41. The apparatus of claim 40, and further comprising means for determining said transaction processing fee based, at least in part, on a risk of default associated with a customer initiating the non-cash transaction.

42. The apparatus of claim 40, and further comprising means for determining said transaction processing fee based, at least in part, on a transaction method associated with said non-cash transaction.

43. The apparatus of claim 40, and further comprising means for determining said transaction processing fee based, at least in part, on a volume purchase agreement associated with said non-cash transaction.

44. The apparatus of claim 40, and further comprising means for determining said transaction processing fee based, at least in part, on an allowable delay associated with payment to settle said non-cash transaction.

45. The apparatus of claim 40, and further comprising means for determining said transaction processing fee based, at least in part, on a payment schedule associated with payment to settle said non-cash transaction.

46. The apparatus of claim 40, wherein said means for receiving said payment request further comprises means for receiving said payment request from a customer initiating said non-cash transaction.

47. The apparatus of claim 40, wherein said means for receiving said payment request further comprises means for receiving said payment request from a merchant.

48. The apparatus of claim 40, and further comprising means for determining said transaction processing fee based, at least in part, on a pre-negotiated schedule.

49. The apparatus of claim 40, and further comprising means for notifying a merchant of said determined transaction processing fee.

50. The apparatus of claim 40, and further comprising means for receiving said payment request from a merchant, said non-cash transaction being initiated from a website operated by said merchant.

51. The apparatus of claim 40, and further comprising means for assessing said transaction processing fee to a merchant as a set off of funds to be paid to merchant to settle said non-cash transaction.

52. The apparatus of claim 40, and further comprising means for assessing said transaction processing fee to a customer to be combined with a value of said non-cash transaction in an invoice to said customer to settle said non-cash transaction.

53. The method of claim 3, wherein said transaction method associated with said non-cash transaction comprises a transaction method selected from the group consisting of an in-person transaction, an on-line transaction and a transaction conducted over the phone.

54. The apparatus of claim 16, wherein said transaction method associated with said non-cash transaction comprises a transaction method selected from the group consisting of an in-person transaction, an on-line transaction and a transaction conducted over the phone.

55. The article of claim 29, wherein said transaction method associated with said non-cash transaction comprises a transaction method selected from the group consisting of an in-person transaction, an on-line transaction and a transaction conducted over the phone.

56. The apparatus of claim 42, wherein said transaction method associated with said non-cash transaction comprises a transaction method selected from the group consisting of an in-person transaction, an on-line transaction and a transaction conducted over the phone.
